(19) United States
(12) Patent Application Publication
(10) Pub. No.: US 2010/0262428 A1
(43) Pub. Date: Oct. 14, 2010

(54) PRINT PLATFORM FOR MOBILE MARKETING

(76) Inventor: Richard Goldsmith, Chappaout, NY (US)

Correspondence Address: KAUTH , POMEROY , PECK & BAILEY ,LLP, 2875 MICHELLE DRIVE, SUITE 110, IRVINE, CA, 92606, US

(21) Appl. No.: 12/757,753

(22) Filed: Apr. 9, 2010

Related U.S. Application Data
(60) Provisional application No. 61/168,129, filed on Apr. 9, 2009.

(51) Int. Cl. G06Q 30/00; G06F 17/30

(52) U.S. Cl. 705/1.1; 707/802; 707/E17.044

(57) ABSTRACT

Systems and processes are provided that merge print and/or direct mailing marketing with mobile marketing to assist marketers to identify an interested consumer with the desired product/service in which messages are transmitted between mobile units and at least one market server to identify and provide specific messages identifying users of the mobile units and offers related to a desired product and/or service. The market server identifies such messages through the use of a market database containing unique keywords and consumer information.

### CROSS-REFERENCE TO RELATED APPLICATIONS

This application claims the benefit of U.S. Provisional Application No. 61/168,129, filed on Apr. 9, 2009, the disclosure of which is hereby incorporated by reference as if set forth in full herein.

### BACKGROUND

This application is generally directed to direct marketing and in particular marketing to mobile phones.

Advertising, a necessary and often most expensive component of marketing provides a way for a provider or seller of goods/services to promote or otherwise inform a potential consumer of the goods/services. Connecting the seller and the consumer to mutually benefit from the exchange of the goods/services is the challenge of marketing. The myriad and diverse forms of marketing over the years have assisted in easing this challenge.

However, with the tremendous amount of information constantly being distributed, often the channels of advertising are restricted or regulated hampering the legitimate and necessary efforts of marketers trying to inform and provide consumers with the product or service they actually desire.

One such regulated and restrictive advertising is advertising to mobile units, e.g., cell phones. A marketer cannot contact a potential consumer through the consumer's mobile unit until the consumer first gives permission to the marketer. This sets up a unique challenge for marketers. For instance, how do consumers know they want to get information about a product without first being provided the knowledge that such a product exists? The marketing challenge, among others, has thus been to create systems and processes in order to inform and thus direct interested consumers to utilize their mobile units to contact the marketer.

Additionally, as part of a double opt-in industry practice, a confirmation action must occur to ensure that the potential consumer giving the permission is actually the consumer providing the permission. Traditionally, such confirmation is performed through a subsequent generic confirmation message, for example, a generic request to reply to a confirmation message sent from the marketer. Accordingly, once an interested consumer contacts the marketer, the marketer ensures the authenticity of the consumer. The challenge then becomes generating an incentive for the consumer to reply to the confirmation message. Thus, there is a need to overcome these above noted challenges while also overcoming the obstacles and shortcomings in the art.

### SUMMARY

The systems and processes provided merge print or direct mail marketing with mobile marketing to assist marketers to identify an interested consumer with the desired product/service.

In one embodiment, a mobile marketing system is provided that comprises at least one mobile device, a market server in communication with the at least one mobile device and a market database in communication with the market server and configured to store customer information. The market server in response to a first message from the at least one mobile device transmits a second message to the at least one mobile device. The second message is part of the stored customer information and is retrieved from the market database by utilizing at least a portion of the first message.

In another embodiment, a method of mobile marketing is provided that comprises transmitting a keyword from at least one mobile device; receiving the keyword by a market server from the at least one mobile device; identifying from keyword, customer information and message; and transmitting the identified message to the at least one mobile device.

In yet another embodiment, a mobile marketing system is provided that comprises a plurality of mobile devices, a market server in communication with at least one of the plurality of mobile devices and is configured to store customer information. The system also includes a print server configured to print a keyword and a short code onto a printed material. At least one of the plurality of mobile devices transmits a message using a keyword and a short code from the printed material to the market server and the market server in response to the message from the at least one of the plurality of mobile devices identifies a response message that includes specific customer information based on the message from the at least one of the plurality of mobile devices.

Many of the attendant features of the present invention will be more readily appreciated as the same becomes better understood by reference to the foregoing and following description and considered in connection with the accompanying drawings in which like reference symbols designate like parts throughout.

### BRIEF DESCRIPTION OF THE DRAWINGS

FIG. 1 is a block diagram of a mobile marketing system in accordance with various embodiments of the invention.

FIG. 2 is a flow diagram of a mobile marketing process in accordance with various embodiments of the invention.

FIG. 3 is a flow diagram of a sending process of a mobile marketing process in accordance with various embodiments of the invention.

FIG. 4 is a flow diagram of a receiving process of a mobile marketing process in accordance with various embodiments of the invention.

FIGS. 5-6 illustrate an exemplary user interface accessing a market database of the mobile marketing system in accordance with various embodiments of the invention.

### DETAILED DESCRIPTION

Overview

Generally, systems and methods are provided to merge print or direct mailing marketing with mobile marketing to comply with a double opt-in practice and to facilitate and enhance the practice, making it seamless and friendly to both the interested consumers and marketers. In accordance with various embodiments of the invention, one or more keywords or codes on mailings are provided to consumers that interested consumers can include in a text message to a marketer. That keyword or code informs a marketer of the consumer's interest in a product or service along with an identifier of that particular consumer. A tailored confirmation message based on the identified consumer is sent to the consumer authenticating the consumer. For ease of description, product marketing will be described although services marketing, giving to non-profit organizations and the like are equally applicable for the systems and processes described throughout the application.

Print or Direct Mailing

Print or direct mailing provides marketers an advertising channel to inform potential customers of a product that does not require a consumer to first contact the marketer. For example, through advertisements in newspapers or magazines or inserts or coupons in mailings sent to a consumer's residence, a marketer informs the consumer of a product. Such advertising could include but is not limited to coupons, one-page advertisements, television and radio advertisement or websites. A short code and an access code or keyword can be added to the advertising. In general, the code and keyword may be communicated to the interested consumer in any fashion as long as it is not first through the mobile unit. In one example, a mailing could indicate that there is a two for one pizza deal. when you send a text message with a SMS short code and a keyword (e.g., “pizza123@98765” or “text pizza123 to 98765 for a two for one pizza deal”). Accordingly, through specific advertising channels such as print or direct mailing, a marketer can introduce and inform potential customers of particular products associated with the marketer and subsequently entice the interested consumers to utilize their mobile unit to contact the marketer.

Mobile Marketing

Based on the particular keyword sent by a mobile unit, the interested consumer is identified. For example, a marketer knows that the sender is interested in the two for one pizza deal and the marketer also can identify the interested consumer. In one embodiment, a particular keyword is generated that identifies a consumer or a group of consumers along with an associated advertising campaign or offer. In response, of the received short code and keyword, a confirmation message is sent back to the interested consumer. The confirmation message authenticates that the consumer wants to participate in the promoted offer or advertising campaign. The confirmation message however is tailored to the identified consumer and can include information unique to the identified consumer. For example, the confirmation message can indicate, do you want us to deliver the pizzas to 123 Main street. Also, based on identifying the consumer, the offer can be modified to include other products that may be of interest to identified consumer. Additionally, unintended consumers can be prevented from responding to an offer not intended for them. Without the unique ID this one-step ordering would not be possible.

In one embodiment, based on the identified consumer, one or more databases can be accessed to correlate an identified consumer's interest or habits that are related to the directed advertising campaign and/or the marketer that initially provided the short code and keyword. Accordingly, instead of a generic confirmation message being sent, a specific tailored message is generated and sent to the identified consumer. Therefore, through tailored confirmation messages, a marketer can subsequently entice the interested consumers to reply to the confirmation message and also introduce and inform potential customers of other particular products associated with the marketer that may be of interest to the identified consumer.

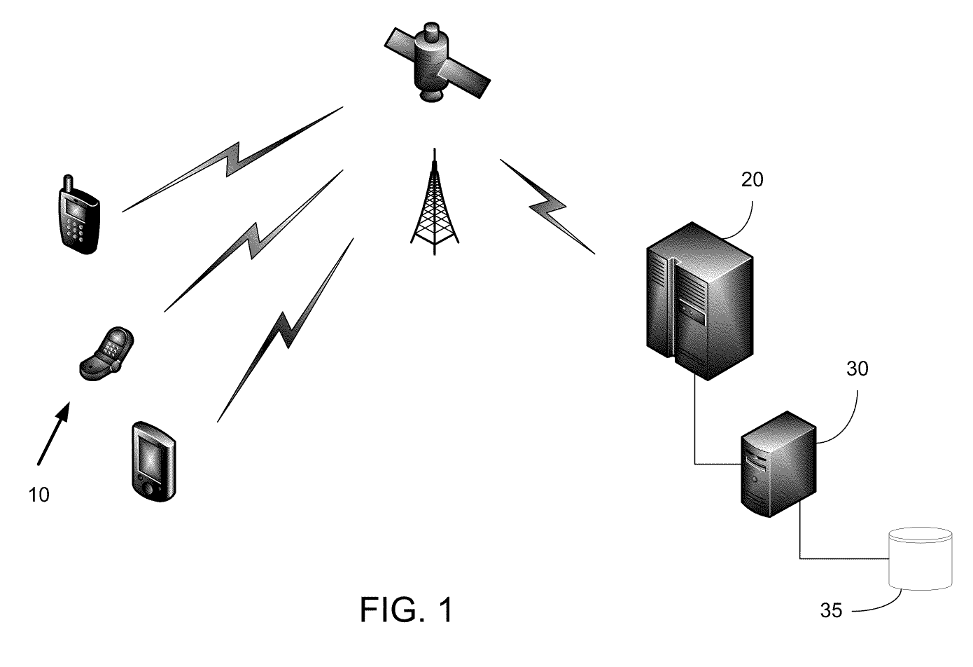

Referring now to FIG. 1, a mobile marketing system in accordance with various embodiments of the invention is provided. The system includes one or more mobile units 10. The mobile units include but are not limited to cell phones, smart phones, satellite phones and other similar mobile devices capable of receiving telephone calls and transmitting electronic data and in particular SMS and MMS Short codes or the like.

Each mobile unit may transmit electronic data that is received by a service provider 20. In one embodiment, the electronic data is a SMS Short Code with a keyword (shared), e.g., “pizza123@98765”, or without a keyword (dedicated) in which the keyword is embedded in the short code, e.g., “77777” that maps or references to the equivalent of “pizza123@98765”. The service provider 20 in this embodiment includes a mobile switching center, short message service center, short message service gateway and more or less components configured to receive the data from the mobile unit and to send electronic data back to the mobile unit.

Also included in the system is a market server 30 operationally connected to or integrated with a market database 35. The market server in one embodiment is connected to the service provider 20 or integrated with the service provider. The market server correlates the received SMS Short Code and keyword to a particular marketer record. The record in one embodiment is retrieved from the market database 35 through a query generated by the market server. The record in one embodiment relates a marketer to a particular marketing campaign associated with the received SMS Short Code. Also included in the record or in another record pointed to by the record is an identifier of the caller or sender of the SMS Short Code. In one embodiment, the market server correlates a mailing list, which includes contact information for one or more consumers, to the received keyword to locate and extract the consumer contact information from the list based on the received key word.

In one embodiment, the mailing lists are obtained from a list owner via an owner's list manager and service bureau. For example, a bank rents a list of names that has been enhanced with demographic information. Keywords are assigned to the contact information in the list as the list is loaded into the server or database.

Utilizing the extracted consumer contact information, the market server queries the market database 35 or other market databases to locate other offers or products that may be of interest to the consumer and thus provide additional offers or rewards that are of interest to the consumer. As such, the market server 30 utilizing the retrieved information generates a confirmation or return electronic message to the sender of the mobile unit 10. The generated confirmation message is thus crafted to specifically be directed at the identified consumer and offers or rewards of interest to the consumer.

For example, because of the specific keyword sent to each specific consumer, when a consumer responds through a mobile unit, the return or confirmation message sent can offer a reward for getting a new credit card that will most likely excite that consumer more than a generic reward. As such, one might be offered a trip to Australia. Another might be offered a new computer.

In one embodiment, the market server includes or is connected to a direct mailing server. The direct mailing server utilizing one or more mailing lists generates a specific keyword for each consumer identified on the mailing list. The specific keyword generated is also matched to a particular marketer and marketing campaign. The short code typically identifies a shared number associated with the market server. The direct mailing server transmits the generated keywords to a marketer that includes the keyword and associated short code on the mailings that are sent to the consumers along with the associated advertisement. In one embodiment, the direct mailing server directly creates the mailings including the specific keywords and associated short codes.

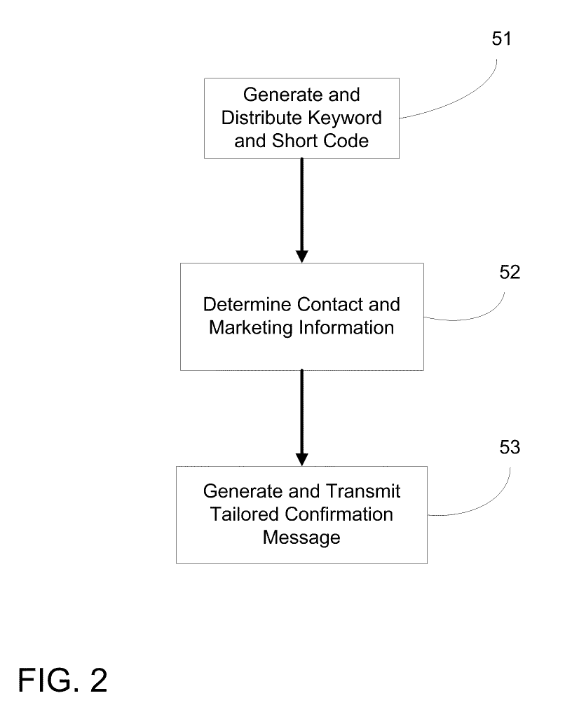

Referring now to FIGS. 2-4, a mobile marketing process in accordance with various embodiments of the invention is provided. First, a keyword and short code is generated and distributed (51). Once distributed the process waits until the keyword and short code is received. Upon reception, the keyword and code is utilized to extract contact and the corresponding marketing information (52). With the extracted information, additional corresponding marketing information associated with the contact information and the marketing information are retrieved to generate a tailored confirmation message that is then transmitted to the sender (53).

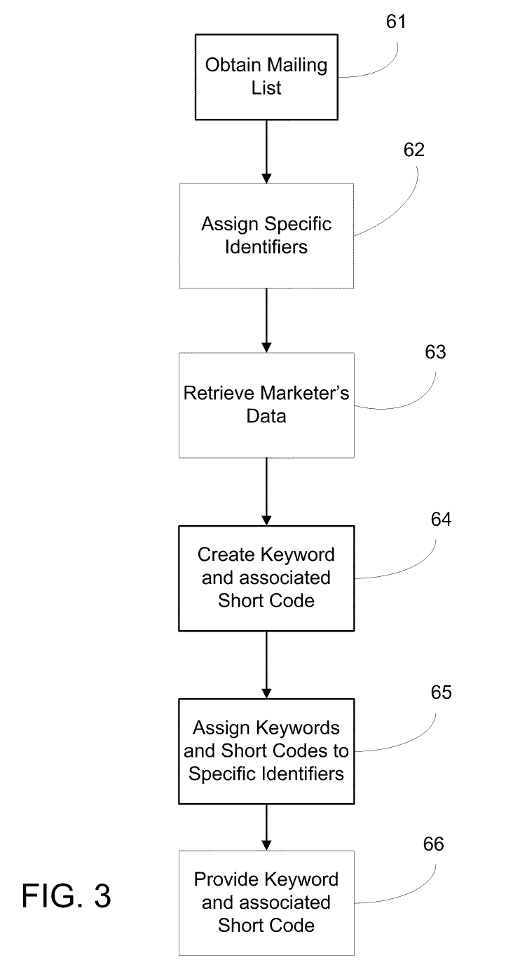

In FIG. 3, additional details of the mobile marketing process in accordance with various embodiments of the invention are provided. The keyword is generated to correlate a specific consumer to a specific marketer and/or marketing campaign. A mailing list is received or retrieved from a service bureau server or database (61) and consumers are assigned specific identifiers (62). Marketer's data is also received or retrieved (63) and includes but is not limited to the marketer's contact information and a specific marketing campaign. Particular keywords (along with an associated Short Code) are then created by utilizing the specific identifiers and the marketer's data (64). Each particular keyword and code is assigned to each specific identifier for each consumer (65). The keywords and codes are then applied to or in one embodiment are stored to be later applied to another printed media, such as a direct mailing. In such an example, a mailing specific to a consumer is affixed with the keyword specific for that consumer. The process thus receives a request for the specific keyword and code (66). The request includes but is not limited to a consumer name, address or phone number. The specific identifier for the consumer is located (66) and the specific keyword and code associated with the located specific identifier (67) are retrieved to be affixed to or provided through another media.

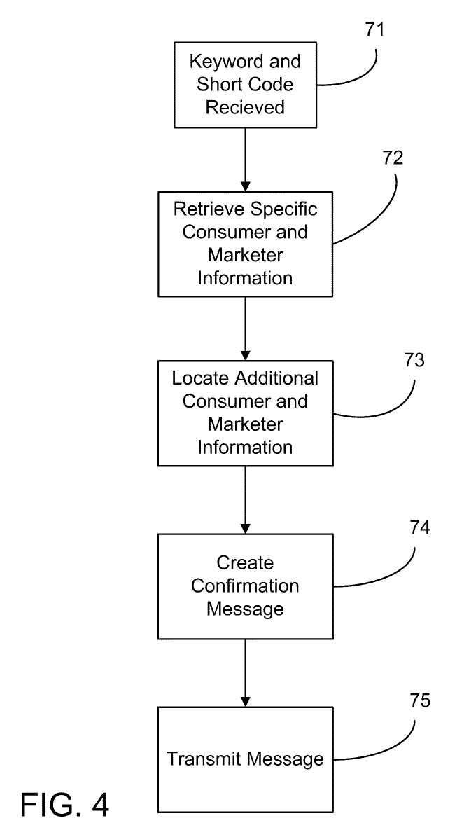

In FIG. 4, additional details of the mobile marketing process in accordance with various embodiments of the invention are provided. A keyword and short code are received (71). The keyword and short code are used to query a database to retrieve a specific consumer and a specific marketer or marketing campaign that were assigned the keyword and short code combination (72). Additional databases are accessed utilizing the retrieved consumer and marketer information to locate additional consumer and/or marketeering information (73). A confirmation message is created based on the retrieved data (74) and transmitted to the sender (75).

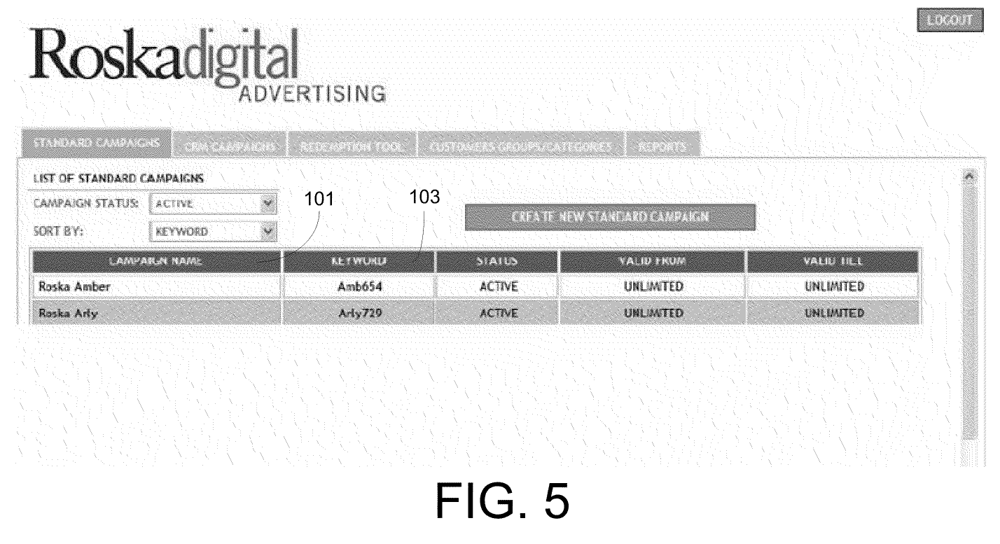

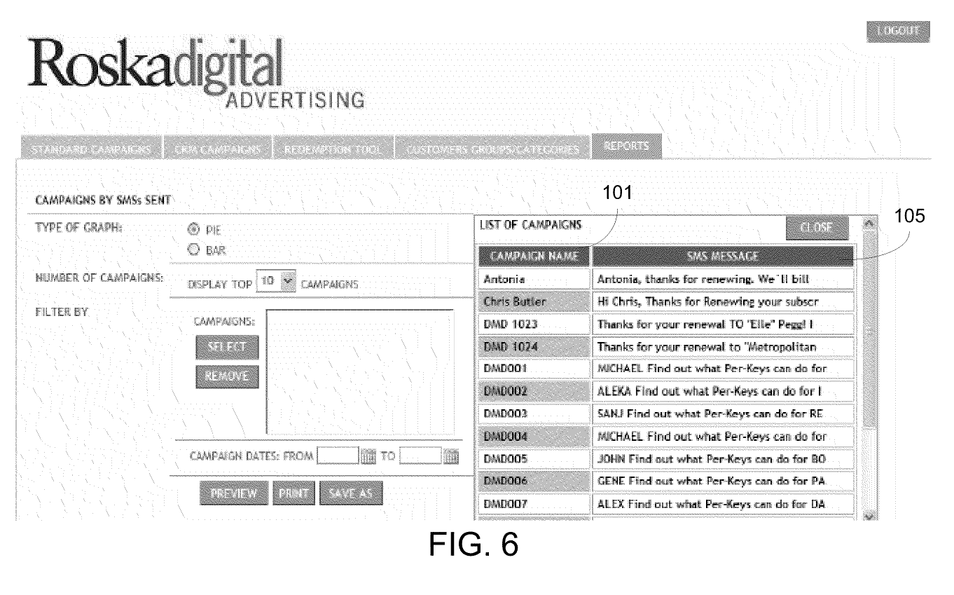

FIGS. 5-6 illustrate an exemplary control panel used to interface with a market server and/or market database containing unique keywords and consumer information. As shown, each keyword 101 is considered a separate campaign and each keyword has a unique message 103 and unique customer information 105. The keyword in one embodiment is generated based on the customer's name and/or other customer identification information. Thus, the market server is able to locate and identify specific customer records in response to messages sent from a customer that match the customer with a specific campaign and thus a specific confirmation or response message without user interaction or intervention. In one embodiment, the market server for example is able to obtain the relevant information to get direct orders when the keyword is used as a response on a cell phone. For instance, a magazine subscription offer is mailed out (renewal notice or new subscription) and says text GOLD123 to 74621 and we'll place your order or renew you for 1 year. Since the keyword is unique, the market server can identify who has responded to the offer. Additionally, the unique response message tailored to the customer can provide the option to pay by dialing a phone number or going to a mobile web site with a hyperlink in the message.

Although the present invention has been described in certain specific embodiments, many additional modifications and variations would be apparent to those skilled in the art. For example, although a specific architecture is described above for associating marketing keywords with customer information other architectures can be used in accordance with embodiments of the invention to generate keywords to send to a customer and to generate confirmation messages including information unique to the customer in response to receipt of the keyword from the customer via the customer's mobile handset. It is therefore to be understood that the present invention may be practiced otherwise than specifically described, including various changes in the size, shape and materials, without departing from the scope and spirit of the present invention. Thus, embodiments of the present invention should be considered in all respects as illustrative and not restrictive.

1. A mobile marketing system comprising:
at least one mobile device;
a market server in communication with the at least one mobile device;
a market database in communication with the market server and configured to store customer information;
wherein the market server in response to a first message from the at least one mobile device transmits a second message to the at least one mobile device, the second message being part of the stored customer information and retrieved from the market database by utilizing at least a portion of the first message.

2. The system of claim 1 wherein the market server identifies a customer from the first message.

3. The system of claim 2 wherein the second message includes information unique to the identified consumer.

4. The system of claim 5 wherein the second message is a text message that includes a person's name.

5. The system of claim 1 wherein the market server locates specific customer information from the stored customer information based on the first message.

6. The system of claim 1 wherein the first message includes a keyword.

7. The system of claim 1 wherein the keyword associates a specific consumer to a specific marketing campaign.

8. The system of claim 1 wherein the market server locates specific customer information from the stored customer information based on the keyword.

9. The system of claim 1 wherein the stored customer information includes a plurality of records correlating customer identifiers to marketing campaigns to unique keywords and messages.

10. The system of claim 1 further comprising a direct mailing server in communication with the market database to obtain keywords.

11. The system of claim 10 further comprising a print server in communication with the direct mailing server providing to the print server a plurality of keywords and consumer information, the print server affixing each of the plurality of keywords with associated consumer information to a printable medium.

12. A method of mobile marketing comprising:
transmitting a keyword from at least one mobile device;
receiving the keyword by a market server from the at least one mobile device;
identifying from keyword, customer information and message; and
transmitting the identified message to the at least one mobile device.

13. The method of claim 12 wherein the at least one mobile device transmits the keyword using a short code.

14. The method of claim 12 further comprising a keyword that is less than one hundred and sixty characters.

15. The method of claim 12 further comprising printing the keyword on a printable medium.

16. The method of claim 12 further comprising supplying the keyword to be printed on a printable medium.

17. A mobile marketing system comprising:
a plurality of mobile devices;
a market server in communication with at least one the plurality of mobile devices and configured to store customer information; and
a print server configured to print a keyword and a short code onto a printed material;
wherein at least one of the plurality of mobile devices transmits a message using a keyword and a short code from the printed material to the market server;
wherein the market server in response to the message from the at least one of the plurality of mobile devices identifies a response message that includes specific customer information based on the message from the at least one of the plurality of mobile devices.

18. The system of claim 17 further comprising a market database storing a plurality of customer records correlating specific customer information to marketing campaigns to keywords and messages.

19. The system of claim 18 further comprising a direct mail server in communication with the market database to obtain keywords and supplying the keywords to the print server.

20. The system of claim 19 wherein the response message includes a person's name.
